(19) United States
(12) Patent Application Publication
(10) Pub. No.: US 2016/0259490 A1
(43) Pub. Date: Sep. 8, 2016

(54) DISPLAY APPARATUS AND DISPLAY CONTROL METHOD

(71) Applicant: Seiko Epson Corporation, Tokyo (JP)

(72) Inventor: Issei Yokoyama, Sapporo-shi (JP)

(21) Appl. No.: 15/049,479

(22) Filed: Feb. 22, 2016

(30) Foreign Application Priority Data
Mar. 4, 2015 (JP) 2015-042482

(51) Int. Cl. G06F 3/0481; G06F 3/0484; G06F 3/0354

(52) U.S. Cl. CPC G06F 3/0481; G06F 3/03545; G06F 3/0484

(57) ABSTRACT

A display apparatus includes a display section configured to display an image on a screen, a detecting section configured to detect the position of an indicator on the screen, a determining section configured to determine, when a start point or an end point of a track of the position of the indicator detected by the detecting section is present at an end or on the outside of the screen and a part of the track is present in an inner region of the screen, a dividing position of the screen according to the track, and a control section configured to divide the screen into a plurality of regions in the dividing position determined by the determining section and control the display section to display different images in the plurality of regions.

The entire disclosure of Japanese Patent Application No. 2015-042482, filed Mar. 4, 2015, is expressly incorporated by reference herein.

### BACKGROUND

1. Technical Field

The present invention relates to a technique for dividing a screen into a plurality of regions and displaying images.

2. Related Art

There has been known a technique for dividing a screen into a plurality of regions and displaying a plurality of images on one screen in a display apparatus such as a projector. For example, JP-A-2009-133985 (Patent Literature 1) describes a technique with which a user selects a desired layout out of predetermined divided layouts. JP-A-2011-158844 (Patent Literature 2) describes a technique for changing the sizes of divided windows according to operation by a user.

In the techniques described in Patent Literatures 1 and 2, the user cannot freely select a dividing position of the screen.

### SUMMARY

An advantage of some aspects of the invention is to provide a technique with which a user can more freely determine, with simple operation, a dividing position of a screen.

An aspect of the invention provides a display apparatus including: a display section configured to display an image on a screen; a detecting section configured to detect the position of an indicator on the screen; a determining section configured to determine, when a start point or an end point of a track of the position of the indicator detected by the detecting section is present at an end or on the outside of the screen and at least a part of the track is present in an inner region of the screen, a dividing position of the screen according to the track; and a control section configured to divide the screen into a plurality of regions in the dividing position determined by the determining section and control the display section to display different images in the plurality of regions.

According to the display apparatus, it is possible to determine the dividing position of the screen according to a track of the indicator moved by a user.

In the display apparatus according to this aspect, the determining section may determine the dividing position of the screen when the start point or the endpoint of the track of the position of the indicator is present at the end or on the outside of the screen, at least apart of the track is present in the inner region of the screen, and the length of the track is a predetermined length or more.

According to the display device with this configuration, it is possible to determine the dividing position of the screen according to a specific track of the indicator moved by the user.

In the display apparatus according to this aspect, the end of the screen may be the upper side or the lower side of the screen, and the determining section may determine the dividing position to horizontally divide the screen.

According to the display apparatus with this configuration, it is possible to horizontally divide the screen by drawing a track passing through the inner region from the upper side or the lower side of the screen.

In the display apparatus according to this aspect, the determining section may determine the dividing position to horizontally divide the screen when the start point of the track of the position of the indicator is present on one of the upper side and the lower side or the outer side of the screen and the end point of the track is present on the other of the upper side and the lower side or the outer side.

According to the display apparatus with this configuration, it is possible to determine the dividing position of the screen according to a specific track of the indicator moved by the user.

In the display apparatus according to this aspect, the end of the screen may be the right side or the left side of the screen, and the determining section may determine the dividing position to vertically divide the screen.

According to the display apparatus with this configuration, it is possible to determine the dividing position of the screen according to a specific track of the indicator moved by the user.

In the display apparatus according to this aspect, the detecting section may detect the positions of two indicators on the screen, and, when a start point or an end point of a track of the two indicators moved while keeping a state in which the two indicators are close to each other at a distance of 1/10 or less of the short side of the screen is present at the end or on the outside of the screen and the track passes through the screen, the determining section may determine the dividing position of the screen according to the track.

According to the display apparatus with this configuration, when the user moves the indicators to draw a track of a predetermined shape, it is possible to determine the dividing position of the screen according to the track.

In the display apparatus according to this aspect, the determining section may determine the dividing position to vertically divide the screen when the start point of the track of the position of the indicator is present on one of the right side and the left side or the outer side of the screen and the end point of the track is present on the other of the right side and the left side or the outer side.

According to the display apparatus with this configuration, it is possible to vertically divide the screen by drawing a track passing through the inner region from the right side or the left side of the screen.

In the display apparatus according to this aspect, the detecting section may detect the positions of two indicators on the screen, and, when a condition that a start point or an end point of a track of the two indicators moved while keeping a state in which the two indicators are close to each other at a distance of 1/10 or less of the short side of the screen is present at the end or on the outside of the screen and at least a part of the track is present in the inner region of the screen is satisfied, the determining section may determine the dividing position of the screen according to the track.

According to the display apparatus with this configuration, when the user moves the indicators to draw a track of a predetermined shape, it is possible to determine the dividing position of the screen according to the track.

In the display apparatus according to this aspect, the determining section may determine the dividing position of the screen according to the track when the track has a predetermined wavy shape.

According to the display apparatus with this configuration, when the user moves the indicator to draw a track of a predetermined wavy shape, it is possible to determine the dividing position of the screen according to the track.

In the display apparatus according to this aspect, the display apparatus may further include an input section configured to receive inputs of video signals from a first video supply apparatus and a second video supply apparatus, and when the track of the indicator has a shape convex in one direction when an image corresponding to the video signal supplied from the first video supply apparatus is displayed on the screen, the control section may display an image corresponding to the video signal supplied from the second video supply apparatus in one region determined according to the direction among the plurality of regions.

According to the display apparatus with this configuration, it is possible to automatically determine a region where a new image is displayed.

In the display apparatus according to this aspect, the display apparatus may further include an input section configured to receive inputs of video signals from a plurality of apparatuses including a first video supply apparatus, a second video supply apparatus, and a third video supply apparatus, and, when the start point or the end point of the track of the position of the indicator detected by the detecting section is present at the end or on the outside of the screen, at least a part of the track is present in the inner region of the screen, and a first image corresponding to a video signal supplied from the first video supply apparatus is displayed on the screen, the control section may cause the display section to display an image object for causing a user to select, from the plurality of apparatuses including the second video supply apparatus and the third video supply apparatus, an image to be displayed in a region other than a region where the first image is displayed among the plurality of regions.

According to the display apparatus with this configuration, it is possible to determine, according to an instruction of the user, a region where a new image is displayed.

Another aspect of the invention provides a display control method including: displaying an image on a screen; detecting the position of an indicator on the screen; determining, when a start point or an end point of a track of the detected position of the indicator is present at an end or on the outside of the screen and at least a part of the track is present in an inner region of the screen, a dividing position of the screen according to the track; and dividing the screen into a plurality of regions in the determined dividing position and controlling screen display to display different images in the plurality of regions.

According to the display control method, it is possible to determine the dividing position of the screen according to a track of the indicator moved by a user.

### BRIEF DESCRIPTION OF THE DRAWINGS

The invention will be described with reference to the accompanying drawings, wherein like numbers reference like elements.

FIG. 1 is a diagram showing the functional configuration of a display apparatus according to an embodiment.

FIG. 2 is a diagram showing the hardware configuration of the display apparatus.

FIG. 3 is a flowchart for explaining the operation of the display apparatus.

FIG. 4 is a diagram illustrating a track that satisfies a start condition.

FIG. 5 is a diagram illustrating a dividing position of a screen.

FIG. 6 is a diagram showing a display example of the screen.

FIG. 7 is a diagram showing another example of a track serving as an opportunity of screen division.

FIG. 8 is a diagram showing another example of the track serving as the opportunity of the screen division.

FIG. 9 is a diagram showing another example of the track serving as the opportunity of the screen division.

FIG. 10 is a diagram illustrating a relation between tracks and screen division.

FIG. 11 is a diagram illustrating a relation between tracks and screen division.

FIG. 12 is a diagram illustrating a UI for selecting a video supply apparatus.

### DESCRIPTION OF EXEMPLARY EMBODIMENTS

### 1. Configuration

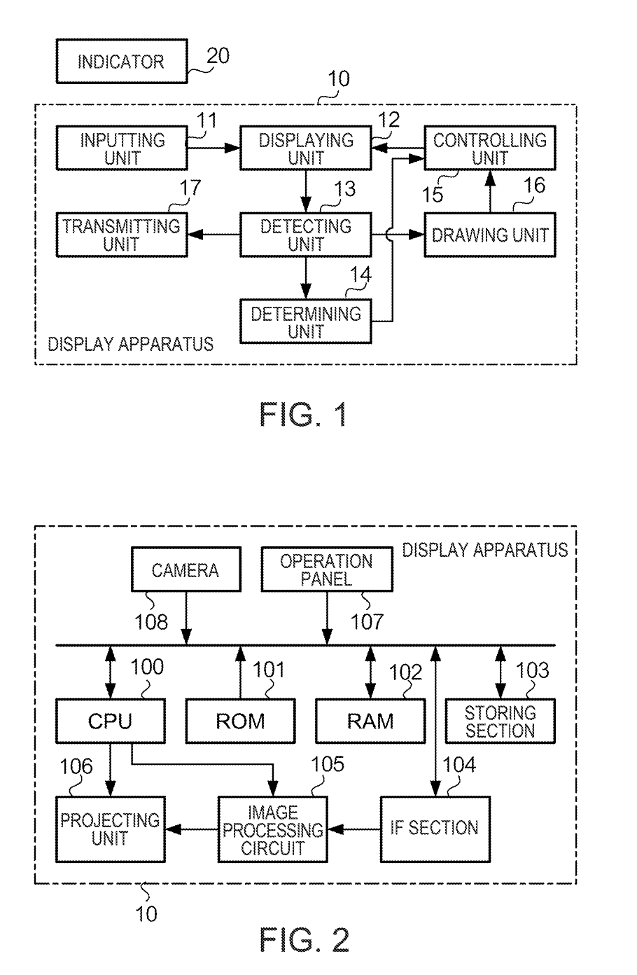

FIG. 1 is a diagram showing the functional configuration of a display apparatus 10 according to an embodiment. The display apparatus 10 has a function of displaying a line drawn according to a track of the position of an indicator 20 on a screen. Further, the display apparatus 10 has a function of dividing the screen and simultaneously displaying videos supplied from a plurality of video supply apparatuses. In particular, the display apparatus 10 has a function of automatically determining a dividing position of the screen according to the track of the indicator 20.

The display apparatus 10 includes an inputting unit 11, a displaying unit 12, a detecting unit 13, a determining unit 14, a controlling unit 15, a drawing unit 16, and a transmitting unit 17.

The inputting unit 11 receives inputs of video signals from the plurality of video supply apparatuses (not shown in the figure). The displaying unit 12 displays an image on the screen. The displaying unit 12 displays an image corresponding to a video signal supplied from at least one video supply apparatus selected from the plurality of video supply apparatuses. The detecting unit 13 detects the position of the indicator 20 on the screen. When a track of the position of the indicator 20 detected by the detecting unit 13 satisfies a predetermined condition, the determining unit 14 determines a dividing position of the screen according to the track. The “predetermined condition” is, for example, a condition that a start point or an end point of the track is present at an end or on the outside of the screen and at least a part of the track is present in an inner region of the screen. The controlling unit 15 divides the screen into a plurality of regions in the dividing position determined by the determining unit 14. Further, the controlling unit 15 controls the displaying unit 12 to display different images in the plurality of regions.

In this example, the display apparatus 10 operates in any one of a plurality of operation modes including a first mode and a second mode. The drawing unit 16 is a function enabled in the first mode. The drawing unit 16 draws a line corresponding to the track of the indicator 20 on the screen. The displaying unit 12 displays, over the image corresponding to the video signal supplied from the video supply apparatus, a line drawn by the drawing unit 16. The first mode is hereinafter referred to as “interactive mode” in the sense that the first mode is a mode in which a line corresponding to operation of the indicator 20 by a user is drawn on the screen.

The transmitting unit 17 is a function enabled in the second mode. The transmitting unit 17 transmits information indicating the position of the indicator 20 on the screen (e.g., a coordinate in a coordinate system defined with respect to the screen) to the video supply apparatus. When the video supply apparatus is an information processing apparatus such as a personal computer (PC), the information is used as an input of a pointing device (e.g., mouse operation). For example, when the user moves the indicator 20 on the screen, a mouse cursor moves following the movement. The mouse cursor is drawn by the video supply apparatus. The second mode is hereinafter referred to as “PC mode” in the sense that the second mode is a mode in which the mouse cursor of the video supply apparatus moves according to operation of the indicator 20 by the user.

FIG. 2 is a diagram showing the hardware configuration of the display apparatus 10. In this example, the display apparatus 10 is a projector. The screen is an image region projected on a projection screen or on a wall surface. The display apparatus 10 includes a CPU (Central Processing Unit) 100, a ROM (Read Only Memory) 101, a RAM (Random Access Memory) 102, an IF section 104, an image processing circuit 105, a projecting unit 106, an operation panel 107, and a camera 108.

The CPU 100 is a control device that controls the sections of the display apparatus 10. The ROM 101 is a nonvolatile storage device having stored therein various computer programs and data. The RAM 102 is a volatile storage device that stores data. The RAM 102 functions as a work area used by the CPU 100 in executing processing.

The IF section 104 is an interface that mediates exchange of signals or data with an external apparatus (e.g., the video supply apparatus). The IF section 104 includes terminals (e.g., a VGA terminal, a USB terminal, a wired LAN interface, an S terminal, an RCA terminal, an HDMI (High-Definition Multimedia Interface: registered trademark) terminal, and a microphone terminal) and a wireless LAN interface for exchanging signals or data with the external apparatus. The terminals may include a video output terminal in addition to a video input terminal.

The image processing circuit 105 applies predetermined image processing (e.g., a size change and keystone correction) to a video signal input thereto (hereinafter referred to as “input video signal”).

The projecting unit 106 projects an image on a projection surface such as a projection screen or a wall surface according to the video signal applied with the image processing. The projecting unit 106 includes a light source, a light modulator, and an optical system (all of which are not shown in the figure). The light source includes a lamp such as a high-pressure mercury lamp, a halogen lamp, or a metal halide lamp or a solid-state light source such as an LED (Light Emitting Diode) or a laser diode and a driving circuit for the lamp or the solid-state light source. The light modulator is a device that modulates, according to the video signal, light radiated from the light source. The light modulator includes, for example, a liquid crystal panel or a DMD (Digital Mirror Device) and a driving circuit for the liquid crystal panel or the DMD. Note that the liquid crystal panel may be either a transmission type or a reflection type. The optical system is configured by, for example, an element that projects the light modulated by the light modulator on the projection screen. The optical system includes, for example, a mirror, a lens, and a prism. The light source and the light modulator may be provided for each color component.

The operation panel 107 is an input device with which the user inputs an instruction to the display apparatus 10. The operation panel 107 includes, for example, a keypad, buttons, or a touch panel.

The camera 108 is a camera for specifying the position of the indicator 20. In this example, the indicator 20 includes a light emitting body (e.g., an infrared light emitting diode), a pressure sensor, and a control circuit (all of which are not shown in the figure) at a pen nib. When the pressure sensor detects contact of the pen nib with an object (the projection surface, etc.), the control circuit causes the light emitting body to emit light in a predetermined light emission pattern. The camera 108 is an infrared camera. The camera 108 photographs an image of the projection surface. The CPU 100 specifies the position of the indicator 20 and an event corresponding to the indicator 20 from the image photographed by the camera 108.

Examples of the event related to the indicator 20 include a pen-down event and a pen-up event. The pen-down event is an event indicating that the indicator 20 is in contact with a display surface (in this example, the projection screen or the wall surface). The pen-down event includes a coordinate indicating a position where the indicator 20 is in contact with the display surface. The pen-up event is an event indicating that the indicator 20 in contact with the display surface is separated from the display surface. The pen-up event includes a coordinate indicating a position where the indicator 20 is separated from the display surface.

Note that the camera 108 is capable of photographing a range (i.e., the outside of the screen) wider than an effective pixel region of the image projected by the projecting unit 106. That is, the display apparatus 10 is capable of detecting the position of the indicator 20 even when the indicator 20 is present outside the screen (as long as the indicator 20 is within a fixed range).

The IF section 104 is an example of the inputting unit 11. The projecting unit 106 is an example of the displaying unit 12. The CPU 100 cooperating with the camera 108 is an example of the detecting unit 13. The CPU 100 is an example of the determining unit 14, the controlling unit 15, and the drawing unit 16. The CPU 100 cooperating with the IF section 104 is an example of the transmitting unit 17.

### 2. Operation

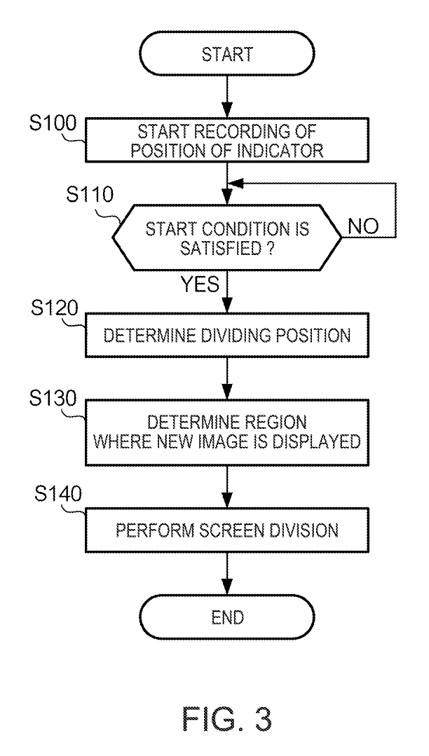

FIG. 3 is a flowchart for explaining the operation of the display apparatus 10. A flow shown in FIG. 3 is executed, for example, with a start of the display apparatus 10 as an opportunity. Alternatively, the flow shown in FIG. 3 may be executed when the user instructs the execution with a setting menu or the like.

In this example, a plurality of video supply apparatuses (e.g., a PC and a DVD player) are connected to the display apparatus 10. Video signals are respectively input to the display apparatus 10 from the video supply apparatuses. At a start point of the flow shown in FIG. 3, the screen is not divided and an image corresponding to a video signal input from a single video supply apparatus (hereinafter referred to as first video supply apparatus; e.g., the PC) is displayed.

In step S100, the CPU 100 starts recording of the position of the indicator 20. In the following explanation, the CPU 100 periodically detects an event related to the indicator 20 from an image photographed by the camera 108 and stores the detected event in the RAM 102. A plurality of events are stored in the RAM 102. The CPU 100 groups the events according to a predetermined rule and treats the events as data indicating a sequential track. For example, after threshold time elapses from the last pen-up event, a pen-down event detected first to a pen-up event detected next are grouped as data indicating a sequential track. In the following explanation, a track of the position of the indicator 20 indicated by the data stored in the RAM 102 is simply referred to as “track”.

In step S110, the CPU 100 determines whether the track satisfies a start condition for screen division. As the start condition for the screen division, for example, a condition described below is used.

(a) A start point of the track is present outside the screen (outside the effective pixel region),

(b) the track traverses a first side of the screen from the start point and enters the inner region (the effective pixel region) of the screen,

(c) the track traverses a second side opposed to the first side of the screen from the inside of the screen and exits to the outside of the screen, and

(d) an endpoint of the track is present on the outside of the screen.

That is, this condition means that “the indicator 20 traverses the screen from one side of the screen to the other side opposed to the one side”. Note that the determination in step S110 may be performed only when a detected event is a specific event (e.g., the pen-up event).

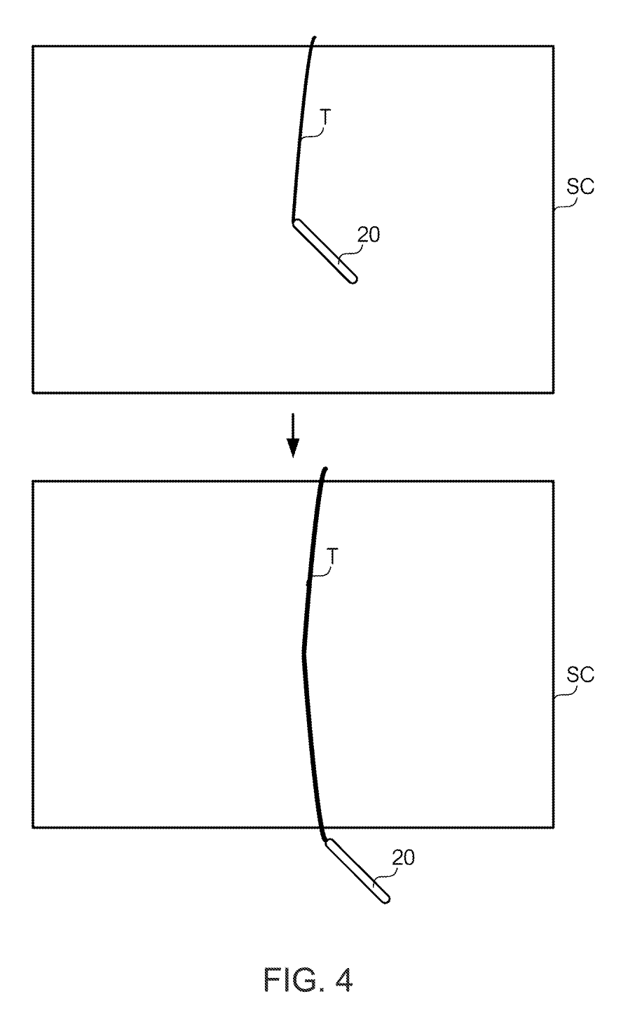

FIG. 4 is a diagram illustrating a track that satisfies the start condition. In this example, a start point of the track is present on the outside of the upper side of a screen SC. The track traverses the screen SC. An end point of the track is present on the outside of the lower side. Note that, in the figure, a track T is shown as a solid line. However, the solid line is shown for explanation and is not actually displayed on the screen.

If determining that the start condition is satisfied (YES in S110), the CPU 100 shifts the processing to step S120. If determining that the start condition is not satisfied (NO in S110), the CPU 100 stays on standby until determining that the start condition is satisfied.

Referring back to FIG. 3, in step S120, the CPU 100 determines a dividing position. The dividing position is determined according to the track. Specifically, for example, the dividing position is determined as explained below. The CPU 100 extracts a representative point from the track. The representative point is, for example, a middle point. The middle point in this case means a point where the distance to the first side and the distance to the second side are equal among points included in the track. Further, the CPU 100 determines a dividing direction from the track of the indicator 20. The dividing direction is, for example, a direction perpendicular to the first side and the second side. The CPU 100 divides the screen with a line that passes the representative point and extends in the dividing direction.

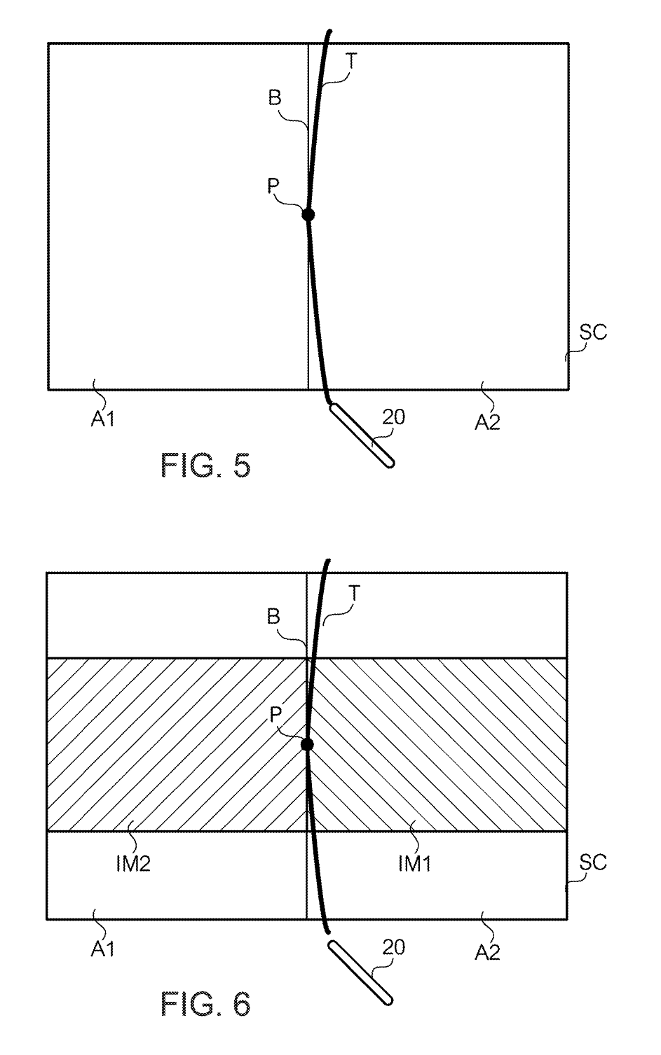

FIG. 5 is a diagram illustrating the dividing position of the screen. In this example, the screen SC and the track T are shown. The track T traverses the screen from the outside of the upper side of the screen and reaches the outside of the lower side of the screen. That is, in this example, the first side is the upper side and the second side is the lower side. A representative point P is a point, a coordinate on a y axis (the ordinate) of which is the center between the upper side and the lower side. In this case, a line B passing the representative point P and perpendicular to the upper side and the lower side is a division line, that is, the boundary between a first region A1 and a second region A2 after the division. In FIG. 5, the screen is horizontally divided by vertically drawing the track. However, for example, when the first side is the left side and the second side is the right side, the screen can be vertically divided.

Referring back to FIG. 3, in step S130, the CPU 100 determines in which of the first region and the second region after the division a new image is displayed. In this example, the new image is an image displayed according to a video signal supplied from a video supply apparatus (hereinafter referred to as second video supply apparatus; e.g., the DVD (Digital Versatile Disk) player) different from the first video supply device.

In this example, the CPU 100 automatically determines, according to the track serving as an opportunity for the screen division, a region where the new image is displayed. Specifically, the region is determined as explained below. The CPU 100 specifies a direction in which the track is convex. For example, the direction in which the track is convex is specified by approximating the track by an arc and determining to which side of the division line the arc is convex. The CPU 100 determines, as the region where the new image is displayed, a region located in the direction in which the track is convex when viewed from the division line.

In step S140, the CPU 100 performs the screen division. That is, the CPU 100 divides the screen into the first region and the second region. The CPU 100 controls the projecting unit 106 to display, in the region determined in step S130, an image corresponding to a video signal supplied from the second video supply apparatus and display, in the other region, an image corresponding to a video signal supplied from the first video supply apparatus.

FIG. 6 is a diagram showing a display example of the screen. In this example, the track T is convex to the left side. Therefore, a new image (an image IM2) is displayed in a region (a region A1) on the left side after the division. An image IM1 displayed before the division is displayed in a region A2, which is the other region. The size of the image IM1 is reduced compared with the size before the division.

As explained above, according to this embodiment, the user can freely determine a dividing position of the screen with simple operation. This operation is performed on condition that the start point and the end point of the track are present on the outside of the screen. Therefore, the operation can be easily distinguished from the drawing operation in the interactive mode and the mouse operation in the PC mode. Further, in this embodiment, the new image is displayed in the region present in the direction in which the track is convex. When a scene of usage in which presentation is performed while an image is projected on a large projection screen, it is assumed that the body of the user (a presenter) is present in the direction in which the track is concave. That is, by displaying the new image in the direction in which the track is convex, it is possible to automatically display the new image in a region not obstructed by the body of the user.

### 3. Modifications

The invention is not limited to the embodiment explained above. Various limited implementations are possible. Several modifications are explained below. Two or more of the modifications explained below may be used in combination.

### 3-1. Modification 1

A start condition of the screen division, that is, a track serving as the opportunity for the screen division is not limited to the start condition explained in the embodiment. As the start condition, any condition may be used as long as, for example, at least one of the start point and the end point of the track is present at the end or on the outside of the screen and at least a part of the track is present in the inner region of the screen. Specifically, the start condition is as explained below. In another example, both of the start point and the endpoint of the track may be present in the inner region of the screen. However, a condition that the screen division is started when the shape of the track has a certain characteristic may be used.

### 3-1-1. Example 1

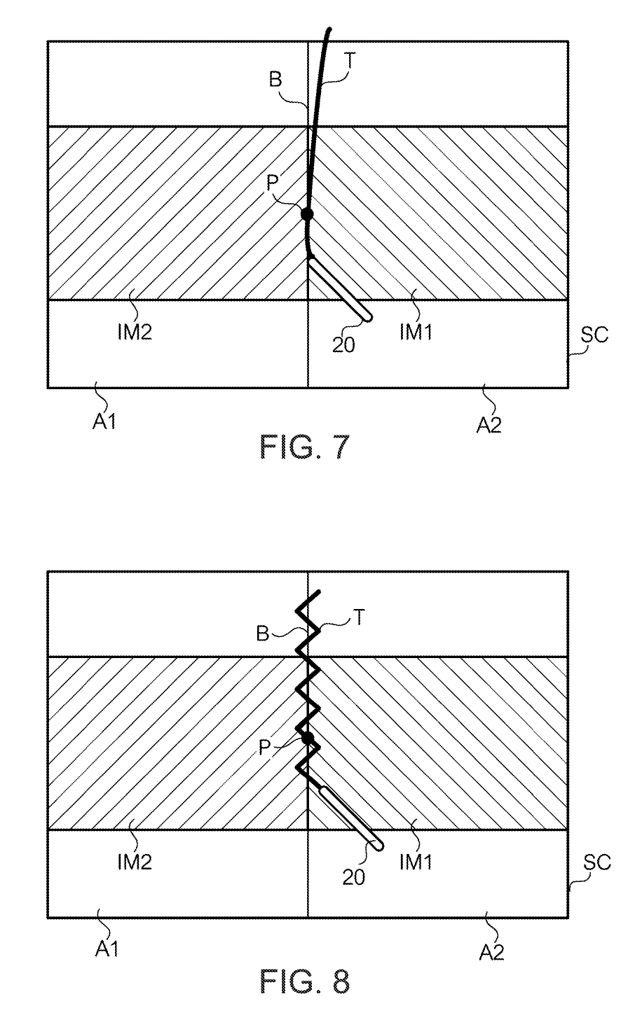

FIG. 7 is a diagram showing another example of the track serving as the opportunity for the screen division. In this example, a condition described below is used as the start condition.

(a) The start point of the track is present outside the screen,

(b) the track traverses one side of the screen from the start point and enters the screen,

(e) the endpoint of the track is present in the inner region of the screen, and

(f) the length of the track is a predetermined length (e.g., a half of the length of the short side of the screen) or more. Note that, in the condition described above, the “start point” and the “end point” may be replaced with each other. In this case, one of the start point and the end point is outside the screen. Therefore, the operation can be easily distinguished from the drawing operation in the interactive mode and the mouse operation in the PC mode.

### 3-1-2. Example 2

FIG. 8 is a diagram showing another example of the track serving as the opportunity for the screen division. In this example, a condition described below is used as the start condition.

(f) The length of the track is a predetermined length (e.g., a half of the length of the short side of the screen) or more, and

(g) the direction of the track in a direction perpendicular to a forward direction of the track changes a predetermined number of times (e.g., five times) or more (that is, the shape of the track is a wavy shape). In this case as well, the operation can be easily distinguished from the drawing operation in the interactive mode and the mouse operation in the PC mode.

### 3-1-3. Example 3

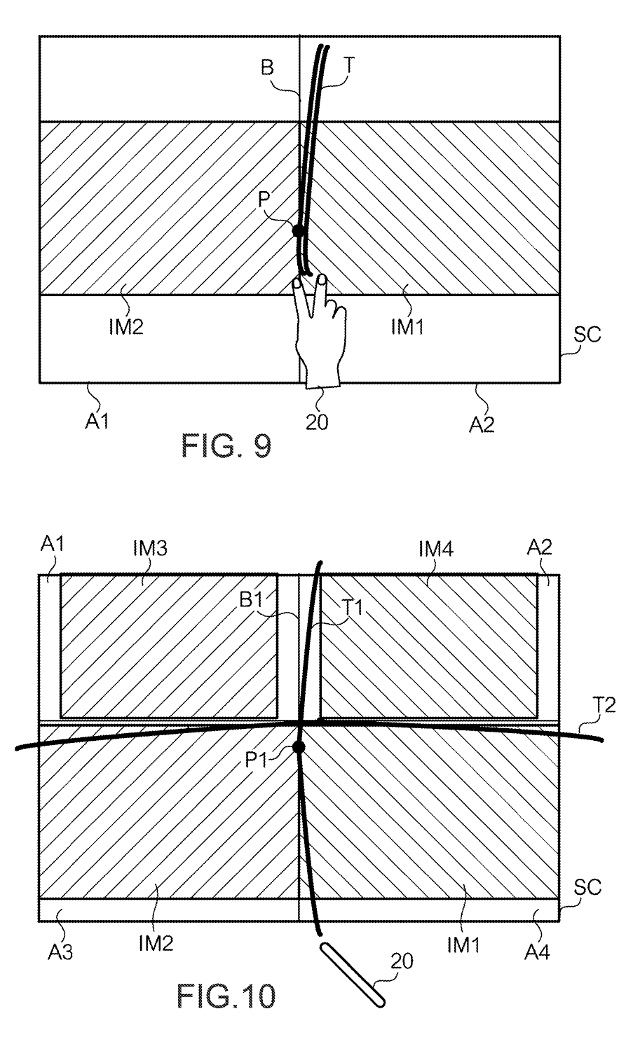

FIG. 9 is a diagram showing another example of the track serving as the opportunity for the screen division. In this example, a condition described below is used as the start condition. The detecting unit 13 is capable of simultaneously detecting the positions of two indicators.

(h) The indicators are fingers of the user,

(i) a track is drawn by two fingers of one hand of the user (that is, the track is a double line), and

(f) the length of the track is a predetermined length (e.g., a half of the length of the short side of the screen) or more. Note that, in this case, the indicator may be two pens rather than the fingers of the user. That is, the screen division may be started when a line having a predetermined length or more is drawn in a state in which points indicated by the two indicators are close to each other (e.g., a state in which the two indicators keep a distance of 1/10 or less of the length of the short side of the screen). In this case as well, the operation can be easily distinguished from the drawing operation in the interactive mode and the mouse operation in the PC mode.

### 3-1-4. Other Examples

The examples 1 to 3 are only illustrations. Any two or more elements of the elements (a) to (i) of the start conditions may be combined and elements other than (a) to (i) may be combined.

### 3-2. Modification 2

In the example explained in the embodiment, the screen is divided into two. However, the number of divisions is not limited to this.

### 3-2-1. Example 1

FIG. 10 is a diagram illustrating a relation between tracks and screen division. In this example, the screen is divided by two tracks T1 and T2. The track T1 is a track extending from the upper side to the lower side of the screen. The track T2 is a track extending from the left side to the right side of the screen. In this example, first, the screen is horizontally divided into two by the track T1. In this state, each of the left and right two regions is vertically divided into two by the track T2. That is, the screen is divided into four regions (regions A1 to A4) in total. Representative points of the tracks T1 and T2 are respectively P1 and P2. The image IM1 is displayed in the region A4. The image IM1 is an original image continuously displayed from the time when the screen division is not performed (when the screen is displayed as one screen). The image IM2 is an image displayed anew by the track T1. Images IM3 and IM4 are images displayed anew by the track T2.

### 3-2-2. Example 2

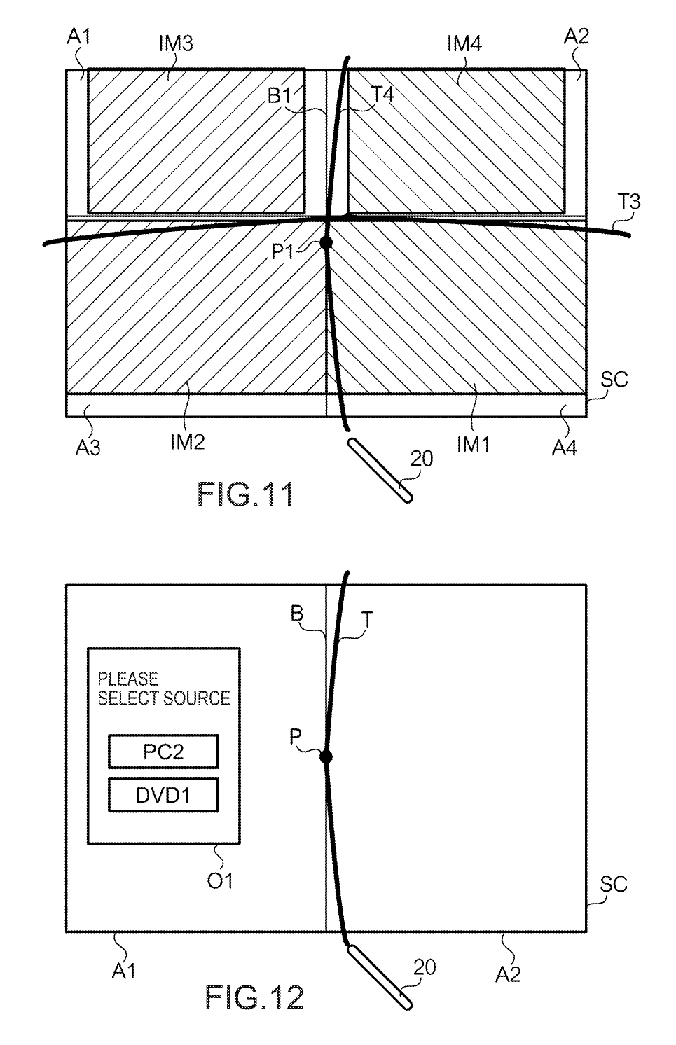

FIG. 11 is a diagram illustrating a relation between tracks and screen division. In this example, the screen is divided by two tracks T3 and T4. The track T3 is a track extending from the left side to the right side of the screen. The track T4 is a track extending from the upper side to the lower side of the screen. In this example, first, the screen is vertically divided into two by the track T3. In this state, each of the upper and lower two regions are horizontally divided by the track T4. That is, the screen is divided into the four regions (the regions A1 to A4) in total. Representative points of the tracks T3 and T4 are respectively P3 and P4. The image IM1 is displayed in the region A4. The image IM1 is an original image continuously displayed from the time when the screen division is not performed (when the screen is displayed as one screen). The image IM2 is an image displayed anew by the track T3. The images IM3 and IM4 are images displayed anew by the track T4.

### 3-3. Modification 3

When video signals are supplied to the display apparatus 10 from three or more video supply apparatuses, it sometimes cannot be automatically determined which video supply apparatus supplies the video signal for displaying images on the screen after the division. In such a case, the CPU 100 may cause the user to select images displayed anew on the screens after the division.

FIG. 12 is a diagram illustrating a UI for selecting a video supply apparatus. The CPU 100 controls the projecting unit 106 to display a UI, that is, an image object O1 for selecting a video supply apparatus in the first region or the second region after the division where a new image is determined to be displayed. In this example, a list of video supply apparatuses is displayed. The user selects, out of the list, a video supply apparatus corresponding to the image to be displayed anew. The CPU 100 determines, according to the selection by the user, a video supply apparatus that supplies a video signal to be displayed as the new image.

### 3-4. Modification 4

In the embodiment, processing for cancelling the screen division is not explained. However, for example, when a track in a direction opposite to the direction of the track serving as the opportunity for the screen division is input, the CPU 100 may cancel the screen division. For example, in FIG. 5, when a track extending from the lower side to the upper side is input, the screen division may be cancelled and the screen may return to the one-screen display.

### 3-5. Other Modifications

The CPU 100 may cause the user to select in which of the regions after the division the new image is displayed. In this case, the CPU 100 controls the projecting unit 106 to display, after the track satisfying the start condition is input, a UI for causing the user to select in which region the new image is displayed.

The screen before the division may be in an interactive mode. In this case, new regions after the division may be other interactive mode screens. Alternatively, images corresponding to manufacturing signals supplied from other video supply apparatuses may be displayed.

A representative point of the track is not limited to the representative point explained in the embodiment. A point for dividing the length of the track into two or a point where an x coordinate or a y coordinate is the largest or the smallest may be used as the representative point. An intersection of the track and an end of the screen may be used as the representative point.

The hardware configuration of the display apparatus 10 for realizing the functions shown in FIG. 1 is not limited to the hardware configuration illustrated in FIG. 2. For example, the display apparatus 10 may detect, using a stereo camera, a position on the screen indicated by the indicator. In another example, the display apparatus 10 may be, rather than the projector, a direct-view display apparatus (a liquid crystal display apparatus or an organic EL display apparatus) including a touch screen. A part of the functions shown in FIG. 1 may be omitted.

What is claimed is:

1. A display apparatus comprising:
a display section configured to display an image on a screen;
a detecting section configured to detect a position of an indicator on the screen;
a determining section configured to determine, when a start point or an end point of a track of the position of the indicator detected by the detecting section is present at an end or on an outside of the screen and at least a part of the track is present in an inner region of the screen, a dividing position of the screen according to the track; and
a control section configured to divide the screen into a plurality of regions in the dividing position determined by the determining section and control the display section to display different images in the plurality of regions.

2. The display apparatus according to claim 1, wherein the determining section determines the dividing position of the screen when the start point or the end point of the track of the position of the indicator is present at the end or on the outside of the screen, at least apart of the track is present in the inner region of the screen, and length of the track is a predetermined length or more.

3. The display apparatus according to claim 2, wherein
the end of the screen is an upper side or a lower side of the screen, and
the determining section determines the dividing position to horizontally divide the screen.

4. The display apparatus according to claim 2, wherein the determining section determines the dividing position to horizontally divide the screen when the start point of the track of the position of the indicator is present on one of an upper side and a lower side or an outer side of the screen and the end point of the track is present on the other of the upper side and the lower side or the outer side.

5. The display apparatus according to claim 2, wherein
the end of the screen is a right side or a left side of the screen, and
the determining section determines the dividing position to vertically divide the screen.

6. The display apparatus according to claim 2, wherein the determining section determines the dividing position to vertically divide the screen when the start point of the track of the position of the indicator is present on one of a right side and a left side or an outer side of the screen and the end point of the track is present on the other of the right side and the left side or the outer side.

7. The display apparatus according to claim 1, wherein
the detecting section detects positions of two indicators on the screen, and
when a start point or an end point of a track of the two indicators moved while keeping a state in which the two indicators are close to each other at a distance of 1/10 or less of a short side of the screen is present at the end or on the outside of the screen and at least a part of the track is present in the inner region of the screen, the determining section determines the dividing position of the screen according to the track.

8. The display apparatus according to claim 1, wherein the determining section determines the dividing position of the screen according to the track when the track has a predetermined wavy shape.

9. The display apparatus according to claim 1, further comprising an input section configured to receive inputs of video signals from a first video supply apparatus and a second video supply apparatus, wherein
when the track of the indicator has a shape convex in one direction when an image corresponding to the video signal supplied from the first video supply apparatus is displayed on the screen, the control section displays an image corresponding to the video signal supplied from the second video supply apparatus in one region determined according to the direction among the plurality of regions.

10. The display apparatus according to claim 1, further comprising an input section configured to receive inputs of video signals from a plurality of apparatuses including a first video supply apparatus, a second video supply apparatus, and a third video supply apparatus, wherein
when the start point or the end point of the track of the position of the indicator detected by the detecting section is present at the end or on the outside of the screen, at least apart of the track is present in the inner region of the screen, and a first image corresponding to a video signal supplied from the first video supply apparatus is displayed on the screen, the control section causes the display section to display an image object for causing a user to select, from the plurality of apparatuses including the second video supply apparatus and the third video supply apparatus, an image to be displayed in a region other than a region where the first image is displayed among the plurality of regions.

11. A display control method comprising:
displaying an image on a screen;
detecting a position of an indicator on the screen;
determining, when a start point or an endpoint of a track of the detected position of the indicator is present at an end or on an outside of the screen and at least a part of the track is present in an inner region of the screen, a dividing position of the screen according to the track; and
dividing the screen into a plurality of regions in the determined dividing position and controlling screen display to display different images in the plurality of regions.
